(19) United States
(12) Patent Application Publication
(10) Pub. No.: US 2025/0217959 A1
(43) Pub. Date: Jul. 3, 2025

(54) ARTICLE INSPECTION APPARATUS

(71) Applicant: ANRITSU CORPORATION, Kanagawa (JP)

(72) Inventors: Takeshi YAMAZAKI, Kanagawa (JP); Akira OHASHI, Kanagawa (JP)

(21) Appl. No.: 19/002,210

(22) Filed: Dec. 26, 2024

(30) Foreign Application Priority Data
Dec. 28, 2023 (JP) 2023-222562

(51) Int. Cl. G06T 7/00; G01N 23/04

(52) U.S. Cl. CPC G06T 7/0004; G01N 23/04; G06T 2207/10116; G06T 2207/20081; G06T 2207/30128

(57) ABSTRACT

An article inspection apparatus that inspects an inspection object article by applying a predetermined image processing algorithm to an inspection image obtained by imaging the inspection object article, the article inspection apparatus comprising a learning unit that evaluates suitability of each of a plurality of image processing algorithms applied to the inspection image based on performance information representing inspection performance in a case where the plurality of image processing algorithms are applied to a plurality of acquired images, and that calculates a plurality of evaluation values representing evaluation results for each of the plurality of image processing algorithms, and an image processing algorithm setting unit that sets a predetermined image processing algorithm used for determining a quality state of the inspection object article based on the plurality of calculated evaluation values.

### TECHNICAL FIELD

The present invention relates to an article inspection apparatus, and more particularly to an article inspection apparatus that inspects a quality state of an inspection object article by applying a predetermined image processing algorithm to an inspection image obtained by imaging a predetermined article type of the inspection object article.

### BACKGROUND ART

In the related art, in the article inspection apparatuses, an image processing algorithm having a predetermined image processing filter corresponding to an inspection item or a combination thereof is applied to imaging data of the inspection object article, so that a predetermined quality state of the inspection object article can be inspected with high accuracy.

In such an article inspection apparatus, it is necessary to select and set an image processing filter or the like corresponding to an inspection item of a specific inspection object article from among a plurality of image processing filters or the like created based on the features of the inspection object article and the features of the foreign matter to be detected and stored in advance in the memory. Therefore, there are some systems that automate the function of selecting and setting the image processing filter or the like necessary for inspection so that such a selection and setting work can be easily performed regardless of the operator's experience.

As this type of article inspection apparatus, for example, an apparatus is known which generates data of a plurality of X-ray images by performing a plurality of types of filter processing according to features on input inspection image data based on detection data of the X-ray amount transmitted through an inspection object article in which the foreign matter is not contained, and selects and sets, as an optimal X-ray image processing filter, a filter that generates data of the X-ray image in which a maximum pixel value is minimized among the data of the plurality of X-ray images in which the brightness of an edge portion image of the article is increased (for example, refer to Patent Document 1).

In addition, in order to extract a desired image processing algorithm approximating the foreign matter detection features capable of detecting the foreign matter to be detected from a plurality of image processing algorithms stored in the storage means, there is a technique for facilitating the selection and setting work by displaying the ranking of image processing algorithms capable of emphasizing the foreign matter while reducing the influence of the inspection object article (for example, refer to Patent Document 2).

### RELATED ART DOCUMENT

### Patent Document

[Patent Document 1] JP-A-2004-28891

[Patent Document 2] JP-A-2012-137387

### DISCLOSURE OF THE INVENTION

### Problem that the Invention is to Solve

However, in the above-described article inspection apparatus in the related art, although high-accuracy foreign matter detection is possible, the functions of detecting and displaying the features of the inspection object article itself tend to be relatively suppressed in order to emphasize the foreign matter therein. Therefore, it is not easy to accurately select and set a necessary image processing algorithm, that is, a combination of a plurality of necessary image processing filters in consideration of a difference in state (density, shape, brightness distribution, or the like of an inspection image corresponding to the difference) such as properties and a form of the inspection object article itself that affect the inspection result.

For example, it is not easy for an unskilled user to select and set an image processing algorithm that accurately corresponds to the inspection object article, and it is not easy to accurately select and set the image processing algorithm from the viewpoint that the setting work using a foreign matter sample is necessary.

Therefore, for example, it is necessary to automatically select the optimal image processing algorithm for the selection result by executing a selection operation input for approximately classifying the state of the inspection object article based on a typical form and size that can be visually observed, and to check that the image processing algorithm is an accurate image processing algorithm in which the detection waveform clearly rises in a case where the foreign matter sample to be detected is mounted.

Further, in a case where a learning stage for learning and storing the X-ray transmission image of the inspection object article with foreign matter is provided in order to obtain high inspection accuracy, there is a concern that it is difficult to sufficiently learn the influence of the properties and the forms of the article itself, which affects the inspection result in a case of overlearning with the learning data focusing on the defective portion, and the optimal image processing algorithm may be omitted from the options.

The present invention has been made in view of the above-described unresolved problems of the related art, and an object of the present invention is to provide an article inspection apparatus that is capable of easily and accurately selecting and setting an image processing algorithm suitable for an inspection object article from a plurality of image processing algorithms.

### Means for Solving the Problem

In order to achieve the above-described object, according to a first aspect of the present invention, there is provided an article inspection apparatus that inspects a quality state of an inspection object article by applying a predetermined image processing algorithm to an inspection image obtained by imaging a predetermined article type of the inspection object article, the article inspection apparatus including: an image processing algorithm storage unit that stores, in advance, a plurality of image processing algorithms including the predetermined image processing algorithm; an image processing algorithm evaluation unit that evaluates suitability of each of the plurality of image processing algorithms applied to the inspection image based on performance information representing inspection performance in a case where the plurality of image processing algorithms are applied to a plurality of acquired images, and that calculates a plurality of evaluation values representing evaluation results for each of the plurality of image processing algorithms; and an image processing algorithm setting unit that sets the predetermined image processing algorithm used for determining the quality state of the inspection object article based on the plurality of evaluation values calculated by the image processing algorithm evaluation unit.

Therefore, in the present invention, by the image processing algorithm evaluation unit, the suitability of the inspection for the data of the inspection image of the inspection object article is evaluated, respectively, based on the performance information representing the inspection performance of the inspection in which the plurality of image processing algorithms are applied to the plurality of acquired images, and the plurality of evaluation values representing each of the evaluation results are calculated. Then, the predetermined image processing algorithm used for determining the quality state of the inspection object article is set by the image processing algorithm setting unit based on the plurality of calculated evaluation values. As a result, the article inspection apparatus can easily, quickly, and accurately select and set an optimal image processing algorithm from among the plurality of image processing algorithms, and can quickly and accurately set an inspection algorithm for executing the article inspection including the image processing and the determination processing.

The data of the inspection image of the inspection object article described herein is, for example, data of an inspection image whose label is not known in a case where a model trained using learning data with a label is used for the selection and setting of the image processing algorithm. In this case, the performance information representing the inspection performance is, for example, performance information labeled on the data of the acquired image, and the evaluation value is, for example, an evaluation index corresponding to an accuracy rate with respect to a correct label, which is a value that can be displayed as a score.

According to a second aspect of the present invention, in the article inspection apparatus of the first aspect, the image processing algorithm evaluation unit calculates the plurality of evaluation values such that numerical values of the evaluation values become larger as the inspection performance represented by the performance information is superior, and the image processing algorithm setting unit selects a superior part of the image processing algorithms from among the plurality of image processing algorithms based on the numerical values of the plurality of evaluation values, and sets the predetermined image processing algorithm.

With this configuration, it is possible to accurately and easily select and set an image processing algorithm having superior inspection performance from among the plurality of image processing algorithms.

According to a third aspect of the present invention, in the article inspection apparatus of the first aspect, the plurality of evaluation values are calculated so as to be a maximum value in a case where the performance information represents inspection performance that is superior to a predetermined level or more, and the image processing algorithm setting unit displays a predetermined number of the image processing algorithms from among the plurality of image processing algorithms in order of superiority of the plurality of evaluation values in a selectable manner on a display device. According to a fourth aspect of the present invention, in the article inspection apparatus of the second aspect, the plurality of evaluation values are calculated so as to be a maximum value in a case where the performance information represents inspection performance that is superior to a predetermined level or more, and the image processing algorithm setting unit displays a predetermined number of the image processing algorithms from among the plurality of image processing algorithms in order of superiority of the plurality of evaluation values in a selectable manner on a display device.

In these cases, it is possible to extract, from among the plurality of image processing algorithms, an image processing algorithm having inspection performance superior to the predetermined level or more, and then to determine the selection of the necessary inspection performance or check it.

According to a fifth aspect of the present invention, in the article inspection apparatus of the first aspect, the image processing algorithm evaluation unit evaluates suitability of the inspection of each of the plurality of image processing algorithms for the inspection image, based on a learning model created in advance through training using, as teacher data, inspection images of a plurality of types of product groups, which are other articles, and an image processing algorithm suitable for the inspection images of the product groups. In addition, according to a sixth aspect of the present invention, in the article inspection apparatus of the second aspect, the image processing algorithm evaluation unit evaluates suitability of the inspection of each of the plurality of image processing algorithms: for the inspection image, based on a learning model created in advance through training using, as teacher data, inspection images of a plurality of types of product groups, which are other articles, and an image processing algorithm suitable for the inspection images of the product groups.

In these cases, training is performed using teacher data that associates inspection images of the plurality of types of product groups, which are the plurality of article types of the inspection object articles of, with image processing algorithms suitable for each of the inspection images, and the trained learning model is created. Therefore, the learning model can exhibit high-accuracy classification performance for the inspection image of the inspection object article, and it is possible to accurately select and set the image processing algorithm.

According to a seventh aspect of the present invention, in the article inspection apparatus of the fifth aspect, the image processing algorithm setting unit extracts at least one image processing algorithm candidate according to evaluation values of the plurality of image processing algorithms based on the learning model in the image processing algorithm evaluation unit, and in a case where the extracted image processing algorithm candidates are plural, the extracted image processing algorithm candidates are displayed on a display device in a selectable manner. In addition, according to an eighth aspect of the present invention, in the article inspection apparatus of the sixth aspect, the image processing algorithm setting unit extracts at least one image processing algorithm candidate according to evaluation values of the plurality of image processing algorithms based on the learning model in the image processing algorithm evaluation unit, and in a case where the extracted image processing algorithm candidates are plural, the extracted image processing algorithm candidates are displayed on a display device in a selectable manner.

In these cases, in a case where an image processing algorithm having superior inspection performance among the plurality of image processing algorithms is clearly specified, it is possible to automatically select and set the image processing algorithm, or to display a plurality of image processing algorithm candidates having a high probability of competing inspection performance and wait for an operation input for determining the selection of the necessary inspection performance, or check it to select and set the image processing algorithm.

According to a ninth aspect of the present invention, in the article inspection apparatus of the fifth aspect, there is provided an article inspection apparatus including a learning unit that has product group storage means for storing images of a product group with which an optimal image processing algorithm among the plurality of image processing algorithms is associated, as learning data, and that generates the learning model based on the learning data. In addition, according to a tenth aspect of the present invention, in the article inspection apparatus of the sixth aspect, there is provided an article inspection apparatus including a learning unit that has product group storage means for storing images of a product group with which an optimal image processing algorithm among the plurality of image processing algorithms is associated, as learning data, and that generates the learning model based on the learning data.

In these cases, since the image of the product group to which the optimal image processing algorithm among the plurality of image processing algorithms is associated can be used as the teacher data, the optimal image processing algorithm can be accurately selected and set for the inspection image of the inspection object article.

According to an eleventh aspect of the present invention, in the article inspection apparatus of the fifth aspect, the learning model is created using a deep learning classification method. In addition, according to a twelfth aspect of the present invention, in the article inspection apparatus of the sixth aspect, the learning model is created using a deep learning classification method.

In these cases, the learning model can accurately classify multidimensional features of the inspection images, respectively, by using a classification method of deep learning using the inspection images of the plurality of types of product groups obtained by imaging other articles other than the inspection object article and the image processing algorithms suitable for each of the inspection images as the teacher data, and can more accurately select and set the necessary image processing algorithm that suitably corresponds to the inspection image, based on the classification results.

According to a thirteenth aspect of the present invention, in the article inspection apparatus of the first aspect, the quality state of the inspection object article is inspected by irradiating the inspection object article with X-rays to acquire an X-ray inspection image and by applying the predetermined image processing algorithm to the X-ray inspection image. In addition, according to a fourteenth aspect of the present invention, in the article inspection apparatus of the second aspect, the quality state of the inspection object article is inspected by irradiating the inspection object article with X-rays to acquire an X-ray inspection image and by applying the predetermined image processing algorithm to the X-ray inspection image.

In these cases, the X-ray inspection apparatus can easily, quickly, and accurately select and set the optimal algorithm from among the plurality of X-ray inspection image processing algorithms.

### Advantage of the Invention

According to the present invention, it is possible to provide an article inspection apparatus that is capable of easily and accurately selecting and setting an image processing algorithm suitable for an inspection object article from a plurality of image processing algorithms.

### BRIEF DESCRIPTION OF THE DRAWINGS

FIG. 1 is a schematic configuration diagram of main parts of an article inspection apparatus of an X-ray inspection method according to one embodiment of the present invention.

FIG. 2 is an explanatory diagram of an output form of an example in a case where a plurality of image processing algorithm candidates suitably corresponding to an input inspection image are extracted in a learning model in the article inspection apparatus of the X-ray inspection method according to one embodiment of the present invention.

FIG. 3 is a conceptual explanatory diagram of an inspection image data set used as teacher data for learning in a learning stage in the article inspection apparatus of the X-ray inspection method according to one embodiment of the present invention.

FIG. 4 is a flowchart showing a procedure of learning in the learning stage in the article inspection apparatus of the X-ray inspection method according to one embodiment of the present invention.

FIG. 5 is a flowchart showing a procedure of extracting a necessary image processing algorithm that suitably corresponds to the inspection image using a trained learning model in the article inspection apparatus of the X-ray inspection method according to one embodiment of the present invention and of selecting and setting the necessary image processing algorithm as an article type parameter.

FIG. 6 is an explanatory diagram of an operation screen used in a case where the necessary image processing algorithm that suitably corresponds to the inspection image is extracted using the trained learning model in the article inspection apparatus of the X-ray inspection method according to one embodiment of the present invention and is selected and set as the article type parameter.

FIG. 7 is a schematic configuration diagram of main parts of an article inspection apparatus of an X-ray inspection method according to another embodiment of the present invention, showing a case where an algorithm evaluation unit is provided in an image processing control unit.

### BEST MODE FOR CARRYING OUT THE INVENTION

Hereinafter, embodiments according to the present invention will be described with reference to the drawings.

### One Embodiment

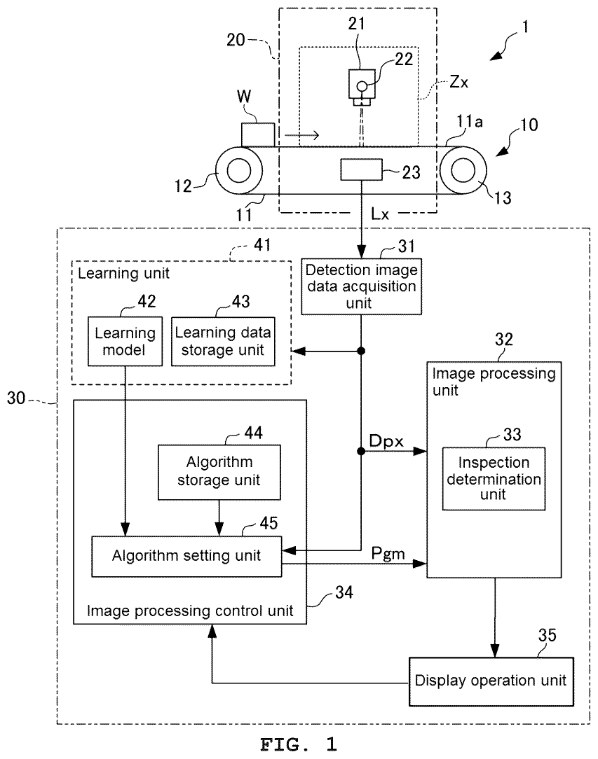

FIGS. 1 to 6 show an article inspection apparatus according to one embodiment of the present invention.

First, a configuration thereof will be described.

As shown in FIG. 1, an article inspection apparatus 1 of the present embodiment includes a transport unit 10, an inspection unit 20, and a control unit 30, detects image data corresponding to transmitted X-ray amount distribution while irradiating an inspection object article W (article to be inspected), which is transported by the transport unit 10 via a conveyor, with X-rays in the inspection unit 20, and inspects a quality state of the inspection object article W based on the detection image data. The quality state described herein suitability of the quality and physical quantities necessary for the inspection object article W as a product, such as the presence or absence of contained foreign matter, the presence or absence of missing items, the acceptability of the shape, size, and storage state of the contents, and the distribution of density, thickness, volume, or mass.

The transport unit 10 is a conveyor that can sequentially transport the inspection object article W in a right direction in FIG. 1 by winding a loop-shaped transport belt 11 around a plurality of transport rollers 12 and 13 and using an upper running section 11a of the transport belt 11, and is supported by a housing (not shown).

The inspection unit 20 is an X-ray inspection unit including an X-ray generator 21 (X-ray source) that generates X-rays in a predetermined energy band transmitted through the inspection object article W transported by the transport unit 10, and an X-ray detector 23 disposed directly below the upper running section 11a of the transport belt 11.

The X-ray generator 21 generates X-rays with a wavelength and an intensity according to a tube current and a tube voltage of a known X-ray tube 22, and can irradiate the inspection object article W in a predetermined inspection section Zx on the transport belt 11 with fan-beam-shaped X-rays in a main observation direction orthogonal to the article transport direction of the transport unit 10 through an X-ray window portion of an envelope (not shown) in detail.

Although not shown in detail, the X-ray detector 23 includes an X-ray line scan camera in which detection elements consisting of a scintillator that is, for example, a phosphor and a photodiode or a charge coupled element are arranged in an array at a predetermined pitch in a width direction of the transport path of the transport unit 10 to perform X-ray detection at a predetermined resolution, and the X-ray detector 23 is disposed at a predetermined position in a transport direction corresponding to the X-ray irradiation position from the X-ray generator 21.

That is, the X-ray detector 23 can detect X-rays emitted from the X-ray generator 21 and transmitted through the inspection object article for each predetermined transmission region corresponding to the detection element, convert the X-rays into an electric signal according to the amount of transmission of the X-rays, and output an X-ray detection signal for generating an X-ray transmission image in which the direction of transmission of the X-rays is the observation direction. Here, the X-rays emitted from the X-ray generator 21 or the X-rays detected by the X-ray detector 23 are assumed to have a certain quality (energy, wavelength) specified according to characteristics of the inspection object article W, but not limited to, a so-called dual-energy or multi-energy X-ray image may be generated by using a plurality of types of X-rays having different X-ray qualities.

Although not shown in detail, the control unit 30 includes transport control means for controlling a transport speed or transport interval of the inspection object article W by the transport belt 11 of the transport unit 10, and inspection control means for controlling an X-ray irradiation intensity or irradiation period of the inspection unit 20 or controlling an X-ray detection period and a detection period of each inspection object article W using the X-ray line sensor of the X-ray detector 23 according to the transport speed of the inspection object article W.

The control unit 30 also has a detection image data acquisition unit 31 that acquires and outputs an X-ray transmission image of each inspection object article W by sequentially acquiring an X-ray detection signal from the X-ray detector 23 for each predetermined period, an image processing unit 32 that executes image analysis processing such as predetermined filter processing (including preprocessing) that can extract an image feature by acquiring the detection image data output from the detection image data acquisition unit 31 and feature measurement for obtaining a feature amount of the extracted image feature, an inspection determination unit 33 that executes determination processing for determining the presence or absence of a predetermined quality state of the inspection object article W, determination processing such as the presence or absence of contained foreign matter, the presence or absence of missing items, or the acceptability of the shape, size, and storage state of the contents, based on the data of the feature amount extracted and measured by the image processing unit 32, an image processing control unit 34 that is capable of updating and changing an inspection algorithm including an image processing algorithm used in the image processing unit 32 and a determination processing algorithm used in the inspection determination unit 33, and a display operation unit 35 (display device) such as a touch panel that is capable of displaying and outputting the determination result by the inspection determination unit 33 and inputting article type registration and other request operations to the image processing control unit 34.

The control 1 unit 30 includes, for example, a microcomputer having a CPU, a ROM, a RAM, and an I/O interface (not shown), an auxiliary storage device that stores a control program for exerting each function of the image processing unit 32, the inspection determination unit 33, and the image processing control unit 34 in cooperation with the ROM in a readable manner, a timer circuit, and the like, and the CPU executes predetermined arithmetic processing while exchanging data with the RAM or the like and executes the control program in accordance with the control program stored in the ROM or the like.

The detection image data acquisition unit 31 exhibits a function as an image input unit, and for example, performs A/D conversion on each of the X-ray detection signals from the plurality of detection elements of the X-ray detector 23, and performs an operation (hereinafter, referred to as line scanning) of writing data of the cumulative transmission amount within the unit time for all the detection element regions of the n detection elements (n is an integer greater than 1, for example, 640) for each predetermined unit transport time corresponding to the size of the detection element in the X-ray detector 23 in the image memory as digital data of the density level represented by gradation from 0 to 1023, for example.

In addition, the detection image data acquisition unit 31 has a data processing program and a work memory (not shown) that exhibit a function of generating data Dpx of the X-ray captured image corresponding to the dose distribution of X-rays transmitted through the inspection object article W based on the detection data Lx of the line scanning image sequentially written in the image memory in a case where the line scanning by the X-ray detector 23 is repeated a predetermined number of times according to the inspection period of the inspection object article W, and outputting the data Dpx to the image processing unit 32 as the imaging data of the inspection object article W.

In the image processing unit 32, a predetermined image processing algorithm in which an image processing filter and the like are combined is set and stored in advance in order to execute predetermined article inspection based on the imaging data Dpx (X-ray captured image data) of the inspection object article W which is acquired from the detection image data acquisition unit 31.

The image processing filter included in the image processing algorithm of the image processing unit 32 is a processing program for extracting image features (for example, an edge, a line, an angle, a region, a shade, or a texture) necessary for the predetermined article inspection based on the imaging data Dpx of the inspection object article W, and in a case where the image processing algorithm includes a filter for foreign matter detection, the image processing filter is a feature extraction filter that performs edge detection processing for emphasizing a contour of the foreign matter in the inspection object article W, for example, a differentiation filter such as a Sobel filter, and performs differentiation processing or the like based on a predetermined arithmetic expression on a region near the interest pixel to emphasize the edge of the foreign matter. The image processing filter “or the like” is intended to include preprocessing such as shading correction or noise removal for the imaging data from the detection image data acquisition unit 31 for improving the detection processing accuracy of the image feature.

In addition, the feature measurement of the image feature executed by the image processing unit 32 is processing of calculating a feature amount necessary for the determination processing of the inspection determination unit 33 by executing the calculation of the attribute (feature amount for characterizing an edge, a region, a distance, a position, a shape, or the like) related to the shade feature, the color feature, the shape feature, or the like, the calculation of the feature amount representing the spatial relationship between such features, or the calculation of the texture feature amount related to the spatial frequency distribution and the direction component, for the image obtained by performing the necessary preprocessing or image processing on the imaging data Dpx of the inspection object article W acquired from the detection image data acquisition unit 31.

The inspection determination unit 33 executes determination processing of determining whether or not a local feature shape or the like corresponding to a foreign matter or a defective portion satisfying the determination condition is included in the inspection object article w by detecting the feature shape, the foreign matter, or the like detected in the inspection object article W based on the feature amount extracted and measured by the image processing unit 32, or comparing the feature amount such as an area, a contour length, and a density sum of the detection target with a predetermined determination criterion value.

As described above, the article inspection apparatus 1 applies the predetermined image processing algorithm Pgm obtained by combining a plurality of types of filter processing and the like to the detection image Dpx obtained by imaging the predetermined article type the inspection object article W and the image data obtained by adding necessary preprocessing or image processing to the detection image Dpx, and inspects a predetermined quality state of the inspection object article W.

On the other hand, the image processing control unit 34 is capable of data communication with a learning unit 41 for machine learning configured by an external PC or the like, and the learning unit 41 is provided with a learning model 42 and a learning data storage unit 43 that stores a data set of image data of each sample and a label indicating an image processing algorithm suitable for (suitably used for) the image data for a plurality of learning samples for training the learning model 42. In the present embodiment, the label of each image processing algorithm stored in the learning data storage unit 43 includes at least the number (identification number) of the image processing algorithm, but may include the name of the algorithm, the name of the inspection target article type indicating the content of the inspection in the algorithm, or the inspection item.

The image processing control unit 34 further includes an algorithm storage unit 44 (image processing algorithm storage unit) that stores in advance a plurality of image processing algorithms Pgm including a predetermined image processing algorithm, and an algorithm setting unit 45 (image processing algorithm setting unit) that is capable of executing update setting processing of updating the image processing algorithm set and stored in the image processing unit 32 to any of the image processing algorithms stored in the algorithm storage unit 44.

The learning unit 41 has a function of creating the learning model 42 that is capable of associating the type of the image processing algorithm suitable for the data of the input inspection image of the article type corresponding to or approximating any of the image data of the plurality of learning samples with any of the class classifications of the plurality of image processing algorithms with which the image processing algorithm suitable for the type is associated, by executing the learning processing or the machine learning processing using the statistical pattern recognition method based on the data set of the plurality of learning samples stored in the learning data storage unit 43.

The statistical pattern recognition method described herein represents a pattern to be classified by a specific high-dimensional feature vector according to the number of classifications, and performs class classification based on a position of the vector in a low-dimensional feature space, and has a learning stage and a recognition stage.

In addition, the data of the input inspection image described herein is data of an inspection image whose label is not known in a case where a trained learning model 42 trained using learning data with a label related to algorithm setting is used. In this case, the performance information representing the inspection performance is, for example, performance information on an algorithm labeled on the data of the acquired image, and an evaluation value is, for example, an evaluation index corresponding to an accuracy rate for a correct label, which is a value that can be displayed as a score.

In the learning stage of the statistical pattern recognition executed by the learning unit 41, the data set of the plurality of learning samples in which the type of suitable image processing algorithm is known as label information of class classification is used, and a type parameter of the image processing algorithm to be class-classified and a parameter representing a distribution state of the image feature of each learning sample in the feature space are calculated from a set of the data set.

In addition, in the recognition stage of the statistical pattern recognition executed by the learning unit 41, feature selection is executed to extract a low-dimensional feature vector effective for the classification based on the feature vector obtained from the input image pattern. The feature selection here is, for example, principal component analysis which linearly projects feature points in a multidimensional space into a low-dimensional subspace with high dispersion (an index of variation in pixel values).

Next, the extracted low-dimensional feature vector is classified to determine which class it belongs in light of the distribution of each class in the feature space, trained using the plurality of learning samples in advance, and the type of the image processing algorithm suitable for the inspection object article W of the input image pattern is specified.

More specifically, the learning unit 41 creates the learning model 42 that can obtain, for example, the feature amount for the plane shape, the three-dimensional shape, or the like using the density, the contour length, and the area as the index value of the shape using a predetermined arithmetic expression, in addition to the statistical feature amount such as the image density dispersion, the average, and the histogram of the data of the sample inspection image associated with the image processing algorithm, the feature data obtained from the data of the inspection image, and the imaging data of the product group that is the same type or similar to the inspection object article w, but not the inspection object article W itself, evaluate suitability (in other words, appropriateness) of the algorithm in the inspection image based on the feature amount (weighted values), and output the evaluation values for each algorithm.

The plurality of types of image processing algorithms that can be classified by the learning unit 41 are stored in the algorithm storage unit 44 as programs, setting parameters, or the like corresponding to each type of the image processing algorithms, and in a case where the learning unit 41 specifies the suitable type of the image processing algorithm based on the imaging data Dpx of the inspection object article W acquired from the detection image data acquisition unit 31, the suitable type of the image processing algorithm is notified and output as the necessary image processing algorithm from the learning model 42 to the algorithm setting unit 45. In a case where the notification of the necessary image processing algorithm is received, the algorithm setting unit 45 executes update setting processing of updating the current image processing algorithm set and stored in the image processing unit 32 to the suitable type of image processing algorithm stored in the algorithm storage unit 44. The algorithm setting unit 45 may execute the update setting processing in a case where the learning unit 41 outputs the notification of the suitable type of image processing algorithm a predetermined number of times instead of once.

The plurality of image processing algorithms stored in the algorithm storage unit 44 include, for example, image filters and other image processing programs suitable for, for example, 30 types of articles that are registered or can be registered as the inspection object article W, and more specifically, are image processing algorithms suitable for any product group of products such as chicken breast meat, items with unevenness, powder, noodle products, and chocolate bags.

The learning unit 41 basically performs supervised learning using the data set of the plurality of learning samples in which the type of the suitable image processing algorithm is known as label information, but it is also conceivable to perform semi-supervised learning in which the number of learning samples is increased by labeling the learning samples without labels based on the classification result obtained by the trained learning model 42. Alternatively, it is also conceivable to perform data augmentation in which, after applying transformation processing such as left-right and up-down inversion, enlargement, reduction, or rotation to the image data of the learning sample, the reclassification by the trained learning model 42 is checked, and the data set of sample images in which there is no change in classification is added to the learning data.

The learning unit 41 also has a function of an image processing algorithm evaluation unit that evaluates, for each of the plurality of image processing algorithms stored in the algorithm storage unit 44, the suitability of the inspection of each image processing algorithm for the data of the input inspection image from the detection image data acquisition unit 31 using the learning model 42, based on performance information that represents the inspection performance in a case where the image processing algorithm is applied to the data of a plurality of acquired images obtained by imaging the plurality of samples which are other articles other than the inspection object article, and calculates a plurality of evaluation values representing the evaluation result of each image processing algorithm as score displayable values.

Then, the algorithm setting unit 45 determines a predetermined image processing algorithm necessary for determining the quality state of the inspection object article W based on the plurality of evaluation values calculated by the learning unit 41 for the plurality of image processing algorithms, and executes update setting processing of updating the current image processing algorithm set and stored in the image processing unit 32 to a necessary image processing algorithm of the suitable type.

More specifically, the learning unit 41 performs learning using the inspection images of a plurality of types of product groups and image processing algorithms suitable for the inspection images of the product groups as teacher data. Accordingly, the learning unit 41 can calculate the described-above evaluation values, which are displayable as scores, such that the evaluation values correspond to a probability (accuracy rate) of falling into the class of the suitable image processing algorithm, and numerical values become larger as the inspection performance represented by the performance information is superior, and display the score on the display operation unit 35.

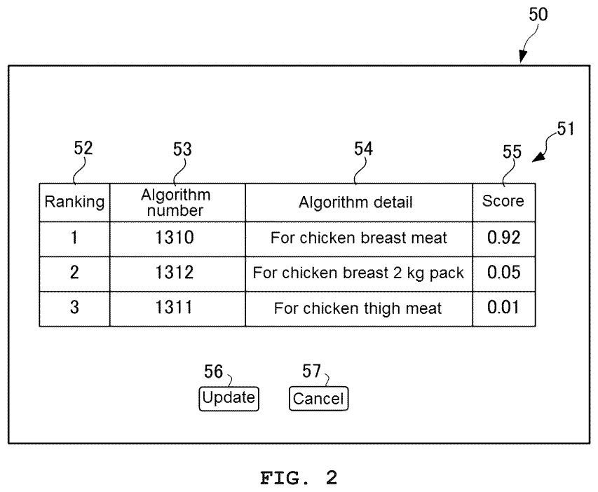

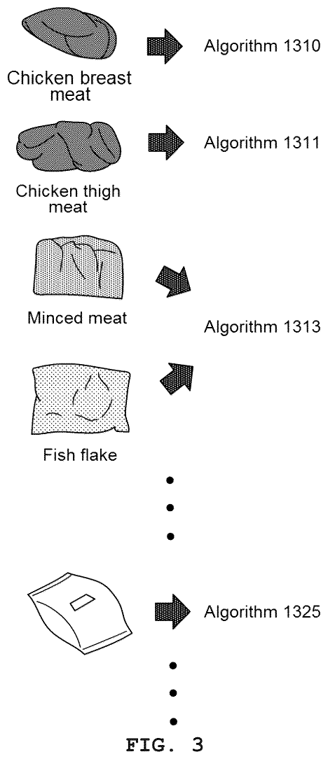

As shown in FIGS. 2 and 3, a score display 51 on the display operation unit 35 by the learning unit 41 displays the data set of the plurality of labeled image processing algorithms in the algorithm selection operation screen 50 (details will be described later) in descending order of the score by a predetermined number of records (three in FIG. 2), and is composed of a ranking field 52 on the left end side, followed sequentially to the right side by an algorithm number field 53 for specifying the image processing algorithm, an algorithm detailed description field 54 for clearly indicating the inspection target of the image processing algorithm, and a score display field 55. In addition, the score display in the score display field 55 in FIG. 2 is displayed as a ratio, expressed as a numerical value of 1 or less, which represents the probability that the same suitable image processing algorithm exists in the specific classification class of the sample image whose image features are in the same classification as the data of the input inspection image from the detection image data acquisition unit 31.

In the example shown in the drawing, regarding the suitability of the inspection of each image processing algorithm for the data of the input inspection image from the detection image data acquisition unit 31, the image processing algorithm of the algorithm number “1310” of which the inspection performance represented by the performance information is most superior is the image processing algorithm candidate ranked first, the detailed description field 54 describes that it is the image processing algorithm for “chicken breast meat”, and the score of the algorithm is displayed as 0.92 (92%). The image processing algorithm for “chicken breast meat” described herein is, for example, an image processing algorithm including an image processing filter suitable for detecting foreign matter such as a bone that remains or adheres to a product of chicken breast meat.

In this case, it is shown that the data of the input inspection image is suitable for the class to which the algorithm number “1310” is classified with a probability of 92%. In addition, since the algorithm number “1312” for “chicken breast 2 kg pack” is ranked second and the score of the image processing algorithm is displayed as 0.05, and the algorithm number “1311” for “chicken thigh meat” is ranked third and the score of the image processing algorithm is displayed as 0.01, it is found that the image processing algorithms ranked second and lower are not suitable.

The algorithm setting unit 45 can set update processing of the image processing algorithm set and stored in the image processing unit 32 using the optimal image processing algorithm automatically selected based on the suitability evaluation result in the learning unit 41 without executing the selection operation input for approximately classifying the state of the inspection object article W based on a typical form, size, or the like that can be visually observed as in the related art.

Alternatively, the algorithm setting unit 45 can select and operate a superior image processing algorithm, for example, the image processing algorithm for “chicken breast meat” shown in FIGS. 2 and 3, from among the plurality of image processing algorithm candidates based on the score display values (numerical values) of the plurality of evaluation values, by the operation screen input from the display operation unit 35, and update and set the predetermined image processing algorithm selected according to the operation input in a case where an update button 56 shown in FIGS. 2 and 3 is operated. The cancel button 57 in FIGS. 2 and 3 is for performing a cancel operation in a case where a selection operation of any one of the plurality of image processing algorithm candidates is erroneous.

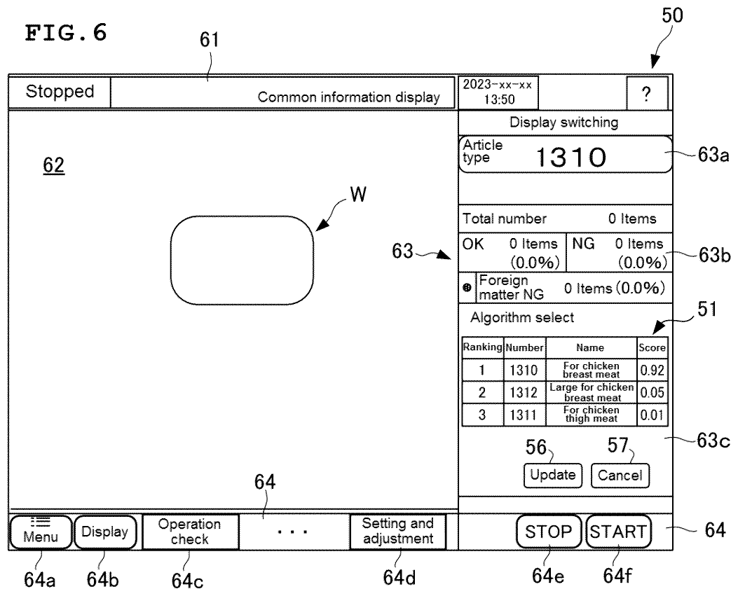

An algorithm selection operation screen 50 (refer to FIG. 6) that selects the image processing algorithm candidates under registration of the article type shown in FIG. 3 is displayed on the touch panel screen (display device) of the display operation unit 35, and an image display region 62 having a predetermined screen size and an inspection information display unit 63 are disposed below a common information display unit 61, and an operation input unit 64 having a plurality of operation buttons is disposed below the image display region 62 and the inspection information display unit 63. In the inspection information display unit 63, an article type number display unit 63a, an inspection result display unit 63b, and a selection content display unit 63c that displays the inspection contents and the image processing algorithm during the inspection, or the operation target and the operation button during the setting operation are disposed. In the operation input unit 64 below the image display region 62, a menu button 64a, a display switching button 64b, an operation check button 64c, a setting and adjustment button 64d, and the like are disposed, and in the operation input unit 64 below the inspection information display unit 63, a stop button 64e and a start button 64f for driving the article inspection apparatus 1 are disposed.

The learning unit 41 may calculate the score, which is the evaluation value of the inspection performance, so as to be the maximum value in a case where the performance information related to the inspection performance represents the inspection performance that is superior to a predetermined level or more, and the algorithm setting unit 45 may display the predetermined plurality of image processing algorithms, for example, three image processing algorithms, from among the plurality of image processing algorithms in order of superiority of the evaluation values in a selectable manner on the algorithm selection operation screen 50 (refer to FIG. 6) of the display operation unit 35.

That is, the algorithm setting unit 45 can extract at least one image processing algorithm candidate according to the evaluation values (scores) of the plurality of image processing algorithms based on the learning model 42 in the learning unit 41, and in a case where the number of the extracted image processing algorithm candidates is plural, the plurality of extracted image processing algorithm candidates can be displayed in a list in a selectable manner on the algorithm selection operation screen 50.

In addition, as described above, the learning unit 41, which is the image processing algorithm evaluation unit, evaluates the suitability of the inspection of the plurality of image processing algorithms (algorithm numbers 1310, 1311, and 1312) for the input inspection image Dpx based on the learning model 42 created in advance by the supervised learning using the inspection images of a plurality of types of product groups which are other articles other than the inspection object article w and the image processing algorithms suitable for the inspection images of the product groups as the teacher data.

The image processing control unit 34 includes the learning unit 41 that has the learning data storage unit 43 (product group storage means) that stores, as learning data, the image data of the product group with which the optimal image processing algorithm among the plurality of image processing algorithms is associated, and that generates the learning model 42 based on the learning data stored in the learning data storage unit 43, in the outside or inside of the apparatus main body of the article inspection apparatus 1 in a data communicable manner.

The learning model 42 performs learning processing or machine learning processing using the statistical pattern recognition method, but may be created using a classification method of deep learning using a convolutional neural network or a support vector machine (SVM) that performs class classification of two classes, for example, a non-linear SVM. In addition, the learning input may be numerical data such as an average value, a dispersion value, a maximum value, and a product size of the pixels instead of the X-ray image itself. Further, in a case where images are used for the learning input, not only X-ray transmission images, but also, in addition to subtraction images using the transmission images of different energy bands, images obtained by the imaging method of different optical systems such as visible light NIR, images obtained by performing the filter processing on the captured image can be used. In addition, an image (for example, refer to JP-A-2023-114827 and JP-A-2023-114828) created by combining a plurality of types of images (each of the above-described images) may be used as in a case where various images are assigned to each channel of a color image such as an RGB image.

In any case, the learning model 42 is typically created by using machine learning (deep learning or other machine learning) of the AI technology, based on the learning data (a set of the inspection images whose suitable image processing algorithm is already known) of the individual articles of the product group other than the inspection object article W, and can acquire, from the top of the evaluation values, the algorithm number and the algorithm name for specifying the image processing algorithm using the learning data of the sample articles stored in the learning data storage unit 43 and the trained learning model 42. Then, at the time of the registration of the article type of the inspection object article W, the learning model 42 can be used to extract the optimal image processing algorithm based on a new input inspection image, which is an inspection target, in a ranking displayable manner, and can be used to display numerical data (probability or the like) of the evaluation value at the same time.

As described above, the article inspection apparatus 1 of the present embodiment acquires data of an input inspection image, which is an X-ray inspection image, by irradiating the inspection object article w to be transported with X-rays in the inspection unit 20, and applies a predetermined image processing algorithm to the data of the input inspection image in the image processing unit 32 to perform X-ray inspection of the quality state of the inspection object article W.

In addition, on the other hand, in a case where the set article type of the inspection object article W is switched or newly set and registered by the display operation unit 35, the control unit 30 of the article inspection apparatus 1 incorporates the data of the input inspection image from the detection image data acquisition unit 31 of the inspection unit 20 into the learning unit 41 and the algorithm setting unit 45 of the image processing control unit 34, and extracts and displays at least one, for example, a plurality of suitable image processing algorithm candidates, which are estimated by the learning model 42 to be suitable for the data of the input inspection image with a high probability. In a case where the optimal image processing algorithm suitable for the inspection object article W of the set article type is automatically selected or selected by the selection operation, the control unit 30 updates the image processing algorithm used in the image processing unit 32 to the optimal image processing algorithm for the article type after the switching by the algorithm setting unit 45.

Next, operations will be described.

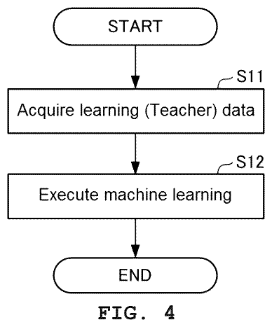

In the present embodiment configured as described above, in the learning stage of the learning unit 41, first, as shown in FIG. 4, a data set of image data of each learning sample and a label indicating an image processing algorithm suitable for the image data is acquired for a plurality of learning samples for training the learning model 42, and stored in the learning data storage unit 43 (Step S11).

Next, the learning unit 41 executes the learning processing or the machine learning processing by the statistical pattern recognition method as described above using the data set of a plurality of learning samples stored in the learning data storage unit 43 to create the learning model 42 that can be associated with any of a plurality of class classifications corresponding to the type of the image processing algorithm suitable for the data of the input inspection image of the inspection object article W (Step S12).

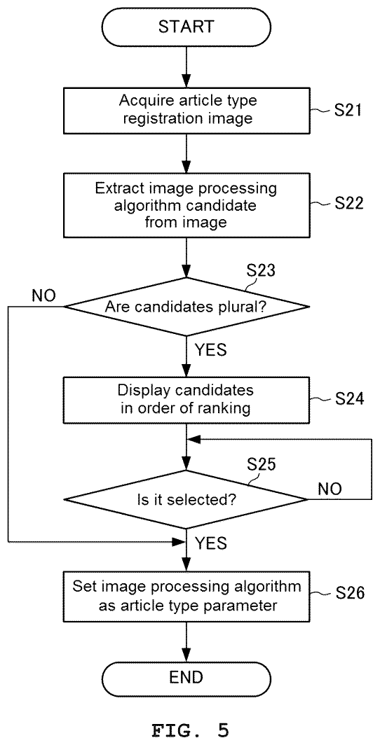

Next, as shown in FIG. 5, in a case where the control unit 30 is input with a setting for registering a predetermined article type by the display operation unit 35 and the inspection object article W for article type registration is test-transported to the article inspection apparatus 1, the inspection object article W is irradiated with X-rays during transport by the inspection unit 20, the X-ray transmitted through the inspection object article W is detected by the X-ray detector 23, and the data of the input inspection image acquired by the detection image data acquisition unit 31 is respectively incorporated into the learning unit 41 and the algorithm setting unit 45 of the image processing control unit 34 (Step S21).

Next, after at least one suitable image processing algorithm candidate estimated to be suitable for the data of the input inspection image with a high probability is extracted by the learning model 42 (Step S22), it is determined whether or not the extracted image processing algorithm candidates are plural (Step S23).

At this time, in a case where the image processing algorithm candidates are plural (in a case of YES in Step S23), the plurality of image processing algorithm candidates are displayed in order of ranking (Step S24). At this time, the ranking may be displayed on a condition that there are a plurality of image processing algorithm candidates having scores equal to or greater than a predetermined value.

Next, in a case where the user refers to the plurality of image processing algorithm candidates displayed in order of ranking as shown in FIG. 2 and waits for a selection operation of any one of the image processing algorithm candidates (in a case of NO in Step S25), in a case where the image processing algorithm candidate determined to be optimal for the inspection object article W to be inspected is selected (in a case of YES in Step S25), or in a case where the image processing algorithm candidate is not plural (in a case of NO in Step S23), the selected one image processing algorithm or the extracted one image processing algorithm is set as a parameter as a part of the inspection algorithm suitable for the inspection object article W to be subjected to the article type registration (Step S26), and the current processing is ended.

As described above, in the article inspection apparatus 1 of the present embodiment, the learning unit 41, which is the image processing algorithm evaluation unit, evaluates the suitability of the inspection for the data of the inspection image of the inspection object article W, information based on the performance representing the inspection performance of the inspection applied to the data of a plurality of acquired images obtained by imaging the product groups which are other articles other than the inspection object article W, and calculates a plurality of evaluation values (scores) representing the evaluation results of the plurality of image processing algorithms. Then, the algorithm setting unit 45 sets the predetermined image processing algorithm used for determining the quality state of the inspection object article W as the necessary image processing algorithm based on the plurality of calculated evaluation values. Therefore, it is possible to easily, quickly, and accurately select and set the optimal image processing algorithm from the plurality of image processing algorithms.

In addition, in the present embodiment, the learning unit 41 calculates the score, which is the evaluation value, such that numerical values become larger as the inspection performance is superior, and the algorithm setting unit 45 selects the image processing algorithm with the superior inspection performance based on the numerical values of the plurality of scores and updates and sets the image processing algorithm. Therefore, it is possible to accurately and easily select and set the image processing algorithm with the superior inspection performance from among the plurality of image processing algorithms.

Further, in the present embodiment, the evaluation value is calculated such that the evaluation value is the maximum value in a case where the performance information indicates the inspection performance that is superior to a predetermined level or more, and the algorithm setting unit 45 displays the predetermined number, for example, three image processing algorithms from among the plurality of image processing algorithms in order of the superiority in a selectable manner. Therefore, it is possible to extract the image processing algorithm having the inspection performance that is superior at the predetermined level or more from among the plurality of image processing algorithms, and the user can determine the selection of the necessary inspection performance or check it.

In addition, in the present embodiment, the learning model 42 is created by performing training using teacher data in which the image processing algorithm suitable for each inspection image is associated with the inspection images of the plurality of types of product groups as the plurality of article types of the inspection object article W, so that the learning model 42 can exhibit high accuracy classification performance for the inspection image of the inspection object article W, and accurate selection and setting of the image processing algorithm can be performed.

In addition, in the present embodiment, in a case where the extracted image processing algorithm candidates are plural, the algorithm setting unit 45 displays the image processing algorithm candidates in a selectable manner on the algorithm selection operation screen 50 of the display operation unit 35 (display device), so that it is possible to accurately select an image processing algorithm having superior inspection performance among the plurality of image processing algorithms, and in a case where the plurality of image processing algorithm candidates having a high probability of competing inspection performance are displayed, it is possible to perform the selection and setting after receiving an operation input for selection determination of necessary inspection performance or check it.

In these cases, in the present embodiment, since the image of the product group to which the optimal image processing algorithm among the plurality of image processing algorithms is associated can be used as the teacher data, the optimal image processing algorithm can be accurately selected and set for the inspection image of the inspection object article W.

In addition, in the present embodiment, in a case where the learning model is created by using the classification method of deep learning, the learning model can accurately classify multidimensional features of the inspection images, respectively, by using the classification method of deep learning using the inspection images of the plurality of types of product groups obtained by imaging other articles other than the inspection object article W and the image processing algorithms suitable for each of the inspection images as the teacher data. Therefore, it is possible to more accurately select and set the necessary image processing algorithm that suitably corresponds to the inspection image based on the classification results.

In the present embodiment, the quality state of the inspection object article W is X-ray inspected by irradiating the inspection object article W with X-rays to acquire an X-ray inspection image and by applying the predetermined image processing algorithm to the X-ray inspection image. Therefore, the article inspection apparatus can easily, quickly, and accurately select and set the optimal image processing algorithm from among the plurality of image processing algorithms for X-ray inspection.

As described above, according to the present embodiment, it is possible to provide the article inspection apparatus 1 that can easily select and set an accurate image processing algorithm corresponding to the inspection object article W from among the plurality of image processing algorithms for article inspection.

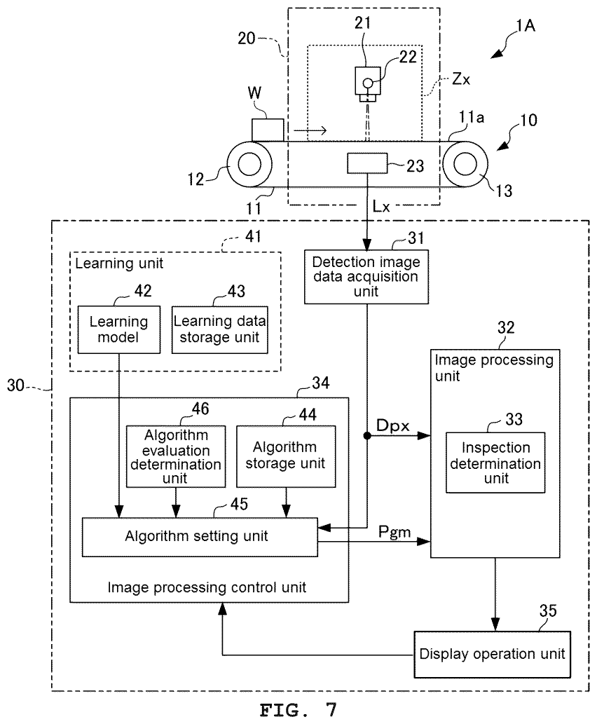

### Another Embodiment FIG. 7 shows an article inspection apparatus 1A according to another embodiment of the present invention.

As shown in FIG. 7, the article inspection apparatus 1A of the present embodiment is different from the article inspection apparatus 1 shown in FIG. 1 in that an algorithm evaluation determination unit 46 is further provided in the image processing control unit 34, but other configurations are the same as those of the article inspection apparatus 1 of one embodiment. Therefore, in FIG. 7, the same configurations as those in one embodiment shown in FIG. 1 are indicated by the same reference numerals as those in FIG. 1. Hereinafter, differences from one embodiment will be described.

In the article inspection apparatus 1A of the present embodiment, an algorithm evaluation determination unit 46 that evaluates the image processing algorithm selected by the user and determines the suitability of the selection is provided in the image processing control unit 34, and the algorithm evaluation determination unit 46 operates in a case where any image processing algorithm candidate that is estimated to be suitable for the data of the input inspection image acquired by the detection image data acquisition unit 31 with a high probability is extracted by the learning model 42 by performing the predetermined setting input for registering the article type to the control unit 30 by the display operation unit 35 and test-transporting the inspection object article W for article type registration, and the image processing algorithm candidate is selected by the user.

During this operation, the algorithm evaluation determination unit 46 has a function of, for example, requesting the test transportation of the inspection object article W with a predetermined number of test pieces on the display screen, executing the image processing in the image processing unit 32 and the determination processing in the inspection determination unit 33 based on the selected image processing algorithm for each test transportation product, and further evaluating the suitability of the selected image processing algorithm by displaying the results on the inspection result display unit 63b and so that it can be checked. In addition, during the operation of the algorithm evaluation determination unit 46, the algorithm setting unit 45 causes the image processing unit 32 to enter an operation state in which the image processing unit 32 can be restored to a state before update without confirming the update setting of the selected image processing algorithm.

The user can refer to the evaluation and determination result in the algorithm evaluation determination unit 46 on the screen, and in a case where the evaluation and determination result is satisfactory, the user can operate the update button 56. However, not only that, in a case where the evaluation values of the two image processing algorithms displayed in the ranking do not differ significantly, the user can operate the cancel button 57 to reselect another image processing algorithm whose evaluation value is next to the once selected image processing algorithm.

Alternatively, it is possible to operate the setting and adjustment button 64d to perform additional setting operation of finely adjusting a part of the parameters in a case where the image processing algorithm selected in the algorithm setting unit 45 is used, and then operate the update button 56 to confirm the update setting state.

Even in the present embodiment, the algorithm evaluation determination unit 46 that functions as the image processing algorithm evaluation unit evaluates the suitability of the inspection for the data of the inspection image of the inspection object article W, based on the performance information representing the inspection performance of the inspection applied to the data of a plurality of acquired images obtained by imaging the product groups which are other articles other than the inspection object article W, and calculates a plurality of evaluation values (scores) representing each of the evaluation results of the plurality of image processing algorithms. Then, the algorithm setting unit 45 sets the predetermined image processing algorithm used for determining the quality state of the inspection object article W as the necessary image processing algorithm based on the plurality of calculated evaluation values. Therefore, even in the present embodiment, the same effects as those of the above-described one embodiment can be obtained.

Further, in the present embodiment, in a case where the image processing algorithm suitable for the data of the input inspection image of the new article type of the inspection object article W is selected, the selected image processing algorithm can be evaluated by the algorithm evaluation determination unit 46 using a predetermined number of test articles before the update setting in the algorithm setting unit 45, and the suitability thereof can be improved.

In the above-described one embodiment, the article inspection apparatus 1 is an X-ray inspection method apparatus, but the present invention can be applied to article inspection apparatuses of various other article inspection methods in which article inspection is performed using imaging data. In addition, as an example of the image processing algorithm, the image processing algorithm suitable for foreign matter detection has been exemplified, but as described above, for example, the suitability of the quality and physical quantities necessary for the inspection object article W as a product, such as the presence or absence of missing items, the acceptability of the shape, size, and storage state of the contents, and the distribution of density, thickness, volume, or mass can be inspected. In addition, it is needless to say that the selection of the image processing algorithm may be accompanied by the selection operation performed in units of inspection algorithms including the image processing algorithm used in the image processing unit 32 and the determination processing algorithm used in the inspection determination unit 33.

As described above, the present invention can provide an article inspection apparatus that is capable of easily and accurately selecting and setting an image processing algorithm suitable for an inspection object article from among a plurality of image processing algorithms, and is useful for article inspection apparatuses in general that inspect a quality state of the inspection object article by applying a predetermined image processing algorithm to an inspection image obtained by imaging a predetermined article type of the inspection object article.

### DESCRIPTION OF REFERENCE NUMERALS AND SIGNS

1, 1A: article inspection apparatus
10: transport unit
11: transport belt
11a: upper running section
12, 13: transport roller
20: inspection unit (X-ray inspection unit)
21: X-ray generator
22: X-ray tube
23: X-ray detector
30: control unit
31: detection image data acquisition unit (image input unit)
32: image processing unit
33: inspection determination unit
34: image processing control unit
35: display operation unit (display device)
41: learning unit (image processing algorithm evaluation unit)
42: learning model
43: learning data storage unit
44: algorithm storage unit (image processing algorithm storage unit)
45: algorithm setting unit (image processing algorithm setting unit)
46: algorithm evaluation determination unit (image processing algorithm evaluation unit)
50: algorithm selection operation screen (touch panel, display device)
51: score display
52: ranking field
53: algorithm number field
54: detailed description field
55: score display field
56: update button
57: cancel button
61: common information display unit
62: image display region
63: inspection information display unit
63a: article type number display unit
63b: inspection result display unit
63c: selection content display unit
64: operation input unit
64a: menu button
64b: display switching button
64c: operation check button
64d: setting and adjustment button
64e: stop button
64f: start button
Dpx: imaging data (inspection image, data of captured image, data of X-ray captured image)
Lx: detection data of line scanning image
W: inspection object article
Zx: inspection region

What is claimed is:

1. An article inspection apparatus that inspects a quality state of an inspection object article by applying a predetermined image processing algorithm to an inspection image obtained by imaging a predetermined article type of the inspection object article, the article inspection apparatus comprising:
an image processing algorithm storage unit that stores, in advance, a plurality of image processing algorithms including the predetermined image processing algorithm;
an image processing algorithm evaluation unit that evaluates suitability of each of the plurality of image processing algorithms applied to the inspection image based on performance information representing inspection performance in a case where the plurality of image processing algorithms are applied to a plurality of acquired images, and that calculates a plurality of evaluation values representing evaluation results for each of the plurality of image processing algorithms; and
an image processing algorithm setting unit that sets the predetermined image processing algorithm used for determining the quality state of the inspection object article based on the plurality of evaluation values calculated by the image processing algorithm evaluation unit.

2. The article inspection apparatus according to claim 1,
wherein the image processing algorithm evaluation unit calculates the plurality of evaluation values such that numerical values of the evaluation values become larger as the inspection performance represented by the performance information is superior, and
the image processing algorithm setting unit selects a superior part of the image processing algorithms from among the plurality of image processing algorithms based on the numerical values of the plurality of evaluation values, and sets the predetermined image processing algorithm.

3. The article inspection apparatus according to claim 1,
wherein the plurality of evaluation values are calculated so as to be a maximum value in a case where the performance information represents inspection performance that is superior to a predetermined level or more, and
the image processing algorithm setting unit displays a predetermined number of the image processing algorithms from among the plurality of image processing algorithms in order of superiority of the plurality of evaluation values in a selectable manner on a display device.

4. The article inspection apparatus according to claim 2,
wherein the plurality of evaluation values are calculated so as to be a maximum value in a case where the performance information represents inspection performance that is superior to a predetermined level or more, and
the image processing algorithm setting unit displays a predetermined number of the image processing algorithms from among the plurality of image processing algorithms in order of superiority of the plurality of evaluation values in a selectable manner on a display device.

5. The article inspection apparatus according to claim 1,
wherein the image processing algorithm evaluation unit evaluates suitability of the inspection of each of the plurality of image processing algorithms for the inspection image, based on a learning model created in advance through training using, as teacher data, inspection images of a plurality of types of product groups, which are other articles, and an image processing algorithm suitable for the inspection images of the product groups.

6. The article inspection apparatus according to claim 2,
wherein the image processing algorithm evaluation unit evaluates suitability of the inspection of each of the plurality of image processing algorithms for the inspection image, based on a learning model created in advance through training using, as teacher data, inspection images of a plurality of types of product groups, which are other articles, and an image processing algorithm suitable for the inspection images of the product groups.

7. The article inspection apparatus according to claim 5,
wherein the image processing algorithm setting unit extracts at least one image processing algorithm candidate according to evaluation values of the plurality of image processing algorithms based on the learning model in the image processing algorithm evaluation unit, and in a case where the extracted image processing algorithm candidates are plural, the extracted image processing algorithm candidates are displayed on a display device in a selectable manner.

8. The article inspection apparatus according to claim 6,
wherein the image processing algorithm setting unit extracts at least one image processing algorithm candidate according to evaluation values of the plurality of image processing algorithms based on the learning model in the image processing algorithm evaluation unit, and in a case where the extracted image processing algorithm candidates are plural, the extracted image processing algorithm candidates are displayed on a display device in a selectable manner.

9. The article inspection apparatus according to claim 5, further comprising:
a learning unit that has product group storage means for storing images of a product group with which an optimal image processing algorithm among the plurality of image processing algorithms is associated, as learning data, and that generates the learning model based on the learning data.

10. The article inspection apparatus according to claim 6, further comprising:
a learning unit that has product group storage means for storing images of a product group with which an optimal image processing algorithm among the plurality of image processing algorithms is associated, as learning data, and that generates the learning model based on the learning data.

11. The article inspection apparatus according to claim 5,
wherein the learning model is created using a deep learning classification method.

12. The article inspection apparatus according to claim 6,
wherein the learning model is created using a deep learning classification method.

13. The article inspection apparatus according to claim 1,
wherein the quality state of the inspection object article is inspected by irradiating the inspection object article with X-rays to acquire an X-ray inspection image and by applying the predetermined image processing algorithm to the X-ray inspection image.

14. The article inspection apparatus according to claims 2,
wherein the quality state of the inspection object article is inspected by irradiating the inspection object article with X-rays to acquire an X-ray inspection image and by applying the predetermined image processing algorithm to the X-ray inspection image.
